(19) United States
(12) Patent Application Publication
(10) Pub. No.: US 2023/0306238 A1
(43) Pub. Date: Sep. 28, 2023

(54) MULTI-LEVEL COORDINATED INTERNET OF THINGS ARTIFICIAL INTELLIGENCE

(71) Applicant: INTERNATIONAL BUSINESS MACHINES CORPORATION, ARMONK, NY (US)

(72) Inventors: Aaron K. Baughman, Cary, NC (US); Shikhar Kwatra, San Jose, CA (US); Vijay Ekambaram, Chennai (IN); Sarbajit K. Rakshit, Kolkata (IN)

(21) Appl. No.: 17/705,873

(22) Filed: Mar. 28, 2022

(51) Int. Cl. G06N 3/04; G06N 3/08

(52) U.S. Cl. CPC G06N 3/0454; G06N 3/08; G16Y 30/00

(57) ABSTRACT

A first plurality of machine learning operations are performed on Internet of Things (IoT) input data in an IoT ecosystem. The first plurality of machine learning operations are performed using a first machine learning level. One or more first machine learning outputs are received from the first machine learning level. A second plurality of machine learning operations are executed on the one or more first machine learning outputs. The second plurality of machine learning operations are executed using a second machine learning level. One or more second machine learning outputs are obtained from the second machine learning level. A third plurality of machine learning operations run on the one or more second machine learning outputs. The third plurality of machine learning operations run using a third machine learning level. An IoT output is identified from the third machine learning level.

### BACKGROUND

The present disclosure relates to Internet of Things (IoT), and more specifically, to operating an IoT ecosystem based on machine learning.

Internet of Things may include the operation of an ecosystem computer-embedded devices e.g., IoT devices. Each of the IoT devices may operate based on artificial intelligence, such as performing machine learning operations. The artificial intelligence may be trained based on the IoT device or an IoT task related to one or more of the IoT devices.

### SUMMARY

According to embodiments, disclosed are a method, system, and computer program product.

A first plurality of machine learning operations are performed on Internet of Things (IoT) input data in an IoT ecosystem. The first plurality of machine learning operations are performed using a first machine learning level. One or more first machine learning outputs are received from the first machine learning level. A second plurality of machine learning operations are executed on the one or more first machine learning outputs. The second plurality of machine learning operations are executed using a second machine learning level. One or more second machine learning outputs are obtained from the second machine learning level. A third plurality of machine learning operations run on the one or more second machine learning outputs. The third plurality of machine learning operations run using a third machine learning level. An IoT output is identified from the third machine learning level.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts the representative major components of an example computer system that may be used, in accordance with some embodiments of the present disclosure;

FIG. 2 depicts an example neural network representative of one or more artificial neural networks, consistent with some embodiments of the present disclosure;

FIG. 3A depicts a system for performing artificial intelligence in an IoT ecosystem, consistent with some embodiments of the disclosure;

FIG. 3B depicts an additional view of the system for performing artificial intelligence in an IoT ecosystem, consistent with some embodiments of the disclosure;

FIG. 3C depicts a first artificial intelligence (“AI”) path of data related to a first IoT task of the system, consistent with some embodiments of the disclosure;

FIG. 3D depicts a second AI path of data related to a second IoT task of the system, consistent with some embodiments of the disclosure;

FIG. 3E depicts a third AI path of data related to a third IoT task of the system, consistent with some embodiments of the disclosure;

FIG. 3F depicts a fourth AI path of data related to a fourth IoT task of the system, consistent with some embodiments of the disclosure;

FIG. 3G depicts a new IoT task performed by the system, consistent with some embodiments of the disclosure; and

FIG. 4 depicts an example method of performing artificial intelligence operations for an IoT ecosystem, consistent with some embodiments of the disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to Internet of Things (IoT), more particular aspects relate to operating an IoT ecosystem based on machine learning. While the present disclosure is not necessarily limited to such applications, various aspects of the disclosure may be appreciated through a discussion of various examples using this context.

IoT ecosystems have become a more comprehensive part of users' homes and everyday lives. IoT may include physical real-world objects that include or are embedded with computers and/or sensors. These computing devices may be configured to run algorithms, and complete tasks in an environment. For example, a refrigerator may be an IoT device, in that the refrigerator may include proximity or motion sensors. The refrigerator may be configured to perform algorithms in response to input data from the sensors. In another example, a smart speaker may include an audio transceiver configured to receive sound and transmit sound in an environment. In yet another example, a smart camera may be configured to capture image data from a video sensor and generate insights based on the video. Further, the IoT devices may also be configured to connect with other devices (including other IoT devices), exchange data, and perform collaborative operations together. For example, a smart television may communicate with a smart speaker to adjust the playing of music and video. The adjustment of the playing of music and video may be based on an activity sensor detecting a user in an environment.

The rise of computing ubiquity has led to ecosystems of IoT devices and further has led to a need for computing algorithms to control the IoT devices. Artificial intelligence is a field of computer software and associated computer techniques that are increasingly used as computing algorithms for IoT scenarios (“AI IoT”). Specifically, artificial intelligence can operate by providing adapting algorithms that are updated or trained, to perform various operations related to IoT devices. For example, each IoT device or each IoT task that relates to a plurality of devices can leverage a machine learning model or neural network to perform or accomplish a goal. The performance of the goal may be fine tuned due to the flexible nature of the machine learning. For instance, a smart speaker may adjust a volume at a first time of day for a user. The smart speaker may employ artificial intelligence to, based on various inputs (e.g., a user requesting a volume adjustment a second time of day, a change in a pattern or behavior of the environment) the smart speaker may in future adjust a volume at a second time of day for the user.

Certain AI IoT may have various computing drawbacks that may lead to various issues with performing IoT tasks.

One drawback is scalability. For instance, an AI IoT may operate by creating, training, and maintaining a single machine learning model for a single device and/or a single task. This may operate at only at a rudimentary level. Specifically, one of the primary benefits of IoT ecosystems is the interoperability of devices. As there are more IoT devices in a particular environment (e.g., a home) there are more actions that can be performed. If five, ten (or more) devices are IoT devices, then particular tasks may be accomplished that could not be done with only one or two IoT devices. For example, a room may be transformed from an open and sun-lit room for creating art, to a home theater with targeted accent lighting if window shades, lights, sound, alarms, and appliances coordinate. Consequently, there is a trend towards more and more AI IoT devices in a given ecosystem. To provide computing resources for many (e.g., three, five, twenty, or more) IoT devices that each operate based on AI requires relatively large amounts of computing resources (e.g., memory, processing, Input/Output (“I/O”) bandwidth).

One way to try and counter resource needs, is to offload or relocate the processing to a central machine and continually scale the computing resources of the central machine. The continuous scaling of computing resources to a computer system may require relatively large amounts of processing cores, memory space, and related power and cooling. For example, dozens of AI machine learning models for each IoT devices may require relatively large (e.g., dozens or more of processors). Further, many IoT steps are performed wastefully or repeatedly. For example, each IoT devices or task may have multiple image detection or noise analysis steps. By having separate IoT AI machine learning models for each IoT device these resources are wasted on performing similar steps repeatedly. This repetition of certain artificial intelligence operations may be relatively power intensive.

Another way to try and counter the scalability needs of computing resources may be to provide embedded or distributed processing of artificial intelligence operations in or near each IoT device. Distributed computing resources may have other drawbacks. For instance, one drawback of performing machine learning operations on an edge device is the limited resources of embedded computing devices. Certain artificial intelligence operations may require performing relatively costly mathematical or other resource intensive operations and may utilize a relatively large computer storage footprint. Many of the embedded computing resources of an IoT device may be configured to only perform relatively limited operations. For example, a smart lamp may have a processor configured to only connect with and transmit and receive data along with saving one or two relatively static attributes about the smart lamp.

In all instances of separate AI machine learning models, another drawback is a lack of machine learning sharing. Specifically, a plurality of disconnected or unrelated machine learning models may learn and/or update in an isolated fashion. As a result, any insights by a first IoT device and/or task may not translate to any of the other AI driven IoT devices or tasks. The lack of shared insights may lead to reduced accuracy as each IoT device does not benefit from pervious operations and AI training performed by other IoT devices. Further, certain IoT tasks are performed rarely (e.g., setting a mood for a holiday or special occasion) and these rarely performed IoT tasks may operate in a rudimentary or untrained state for a relatively long time (e.g., months, years). For example, a holiday IoT task may operate by adjusting certain lights and devices in an IoT ecosystem for a holiday once a year. The holiday IoT task may rely on a separate machine learning model for the holiday IoT task. The holiday IoT task may not have reduced energy usage or may inaccurately adjust the various IoT devices due to the rarely performed holiday IoT task. Even when various IoT devices are used relatively frequently (e.g., daily, weekly), the lack of AI sharing means that those same IoT devices have reduced performance when used as part of the holiday IoT task.

Multi-Level Coordinated Internet of Things Artificial Intelligence (“MLC”) may have advantages versus other techniques for performing artificial intelligence operations. For example, MLC may operate to perform IoT operations related to an IoT ecosystem of devices in a shared real-world environment. MLC may operate by combining various separate machine learning (“ML”) operations—from separate ML models and/or neural networks (“NNs”)—into a cooperative or coordinated artificial intelligence. Specifically, multiple ML models may be chained together by the MLC and form a path or hierarchy in a singular AI. For instances, one or more ML models and/or neural networks may form levels of ML operations. The MLC may direct data between the various levels of the hierarchy in a coordinated fashion to perform AI IoT operations.

Requests to perform multiple different IoT tasks may be handled by the MLC as a single multi-level AI instead of a separate ML model for each separate AI task. Further, the MLC may direct and route data between ML models and/or NNs for processing of the requests. In detail, the MLC may operate by applying the results of a plurality of ML operations from one level and directing that output to another level of additional pluralities of ML operations. Each of the levels may include one or more ML models and/or NNs; and each ML model and/or NN may be related to an IoT device and/or an IoT task. For example, the MLC may operate by directing the output of a first level of machine learning operations to a second level of machine learning operations and direct the output of the second level to additional levels of machine learning operations.

The MLC may be configured to receive IoT requests, such as to set a scene in a room of a house for morning. The request may include request data, such as what room, from what devices, from which user. Based on the request data of the IoT requests, and IoT data of an ecosystem of devices, provide an AI response. For example, in response to receiving the “morning time” IoT task request in a home, the MLC may turn on IoT lights, adjust IoT window blinds, and play particular music from an IoT speaker.

The MLC may operate by providing responses to multiple IoT devices and tasks with relatively more efficient usage of computing resources as compared to a set of separate IoT AIs for each IoT task. In detail, the MLC may operate by training one or more ML models and/or NNs in a given level only a single time. These singularly trained ML models and/or NNs may be leveraged repeatedly without requiring additional training, which reduces the usage of computing resources. These singularly trained ML models and/or NNs may be considered reusable and extensible building blocks of the larger MLC. After being generated only a single time, each of these singularly trained components of the MLC may not need to be trained again but may provide the same accuracy and benefit as one or more layers of a singular ML model and/or NN configured to perform similar operations.

Further, one or more ML levels may be trained to generate an output that is agnostic to a particular IoT task. Specifically, certain ML models and/or NNs of the MLC may perform AI operations without considering any IoT task or without outputting any ML output relevant to a particular IoT task. Further, by ML models and/or NNs of the MLC not considering any IoT task in particular, the complexity of other portions of the MLC may be reduced. For example, a previously trained task agnostic portion ML model and/or NN may be directed to output to a new task aware ML model and/or NN. The task aware ML model may benefit by performing fewer operations and having fewer layers of AI logic. These reduced complexity NNs may operate in a relatively more optimized fashion, such as with a reduced number of processing cycles or a reduced memory footprint. Additionally, the MLC may operate by reusing previously trained levels of NNs in a new context combined without having to train all AI logic for the new AI IoT task. Specifically, accuracy and quality of existing task agnostic ML models and/or NNs may be preserved and reused for new tasks.

In some embodiments, the method, system, and computer program product described herein use AI. AI is an example of a cognitive system that relates to the field of computer science directed at computers and computer behavior as related to humans and man-made and natural systems. Cognitive computing utilizes self-teaching algorithms that use, e.g., data analysis, visual recognition, behavioral monitoring, and natural language processing (NLP) to solve problems and optimize technical processes. The data analysis and behavioral monitoring features analyze the collected relevant data and behaviors as subject matter data as received from the sources as discussed herein. As the subject matter data is received, organized, and stored, the data analysis and behavioral monitoring features analyze the data and behaviors to determine the relevant details through computational analytical tools which allow the associated systems to learn, analyze, and understand human behavior, including within the context of the present disclosure. With such an understanding, the AI can surface concepts and categories, and apply the acquired knowledge to teach the AI platform the relevant portions of the received data and behaviors. In addition to analyzing human behaviors and data, the AI platform may also be taught to analyze data and behaviors of man-made and natural systems.

In addition, cognitive systems such as AI, based on information, are able to make decisions, which maximizes the chance of success in a given topic. More specifically, AI is able to learn from a dataset, including behavioral data, to solve problems and provide relevant recommendations. For example, in the field of artificial intelligent computer systems, machine learning (ML) systems process large volumes of data, seemingly related or unrelated, where the ML systems may be trained with data derived from a database or corpus of knowledge, as well as recorded behavioral data. The ML systems look for, and determine, patterns, or lack thereof, in the data, “learn” from the patterns in the data, and ultimately accomplish tasks without being given specific instructions. In addition, the ML systems, utilizes algorithms, represented as machine processable models, to learn from the data and create foresights based on this data. More specifically, ML is the application of AI, such as, and without limitation, through creation of neural networks that can demonstrate learning behavior by performing tasks that are not explicitly programmed. Deep learning is a type of neural-network ML in which systems can accomplish complex tasks by using multiple layers of choices based on output of a previous layer, creating increasingly granular and discerning conclusions.

ML learning systems may have different “learning styles.” One such learning style is supervised learning, where the data is labeled to train the ML system through telling the ML system what the key characteristics of a thing are with respect to its features, and what that thing actually is. If the thing is an object or a condition, the training process is called classification. Supervised learning includes determining a difference between generated predictions of the classification labels and the actual labels, and then minimize that difference. If the thing is a number, the training process is called regression. Accordingly, supervised learning specializes in predicting the future.

A second learning style is unsupervised learning, where commonalities and patterns in the input data are determined by the ML system through little to no assistance by humans. Most unsupervised learning focuses on clustering, i.e., grouping the data by some set of characteristics or features. These may be the same features used in supervised learning, although unsupervised learning typically does not use labeled data. Accordingly, unsupervised learning may be used to find outliers and anomalies in a dataset, and cluster the data into several categories based on the discovered features.

Semi-supervised learning is a hybrid of supervised and unsupervised learning that includes using labeled as well as unlabeled data to perform certain learning tasks. Semi-supervised learning permits harnessing the large amounts of unlabeled data available in many use cases in combination with typically smaller sets of labelled data. Semi-supervised classification methods are particularly relevant to scenarios where labelled data is scarce. In those cases, it may be difficult to construct a reliable classifier through either supervised or unsupervised training. This situation occurs in application domains where labelled data is expensive or difficult obtain, like computer-aided diagnosis, drug discovery and part-of-speech tagging. If sufficient unlabeled data is available and under certain assumptions about the distribution of the data, the unlabeled data can help in the construction of a better classifier through classifying unlabeled data as accurately as possible based on the documents that are already labeled.

The third learning style is reinforcement learning, where positive behavior is “rewarded: and negative behavior is “punished.” Reinforcement learning uses an “agent,” the agent's environment, a way for the agent to interact with the environment, and a way for the agent to receive feedback with respect to its actions within the environment. An agent may be anything that can perceive its environment through sensors and act upon that environment through actuators. Therefore, reinforcement learning rewards or punishes the ML system agent to teach the ML system how to most appropriately respond to certain stimuli or environments. Accordingly, over time, this behavior reinforcement facilitates determining the optimal behavior for a particular environment or situation.

Deep learning is a method of machine learning that incorporates neural networks in successive layers to learn from data in an iterative manner. Neural networks are models of the way the nervous system operates. Basic units are referred to as neurons, which are typically organized into layers. The neural network works by simulating a large number of interconnected processing devices. There are typically three parts in a neural network, including an input layer, with units representing input fields, one or more hidden layers, and an output layer, with a unit or units representing target field(s). The units are connected with varying connection strengths or weights. Input data are presented to the first layer, and values are propagated from each neuron to every neuron in the next layer. At a basic level, each layer of the neural network includes one or more operators or functions operatively coupled to output and input. Output from the operator(s) or function(s) of the last hidden layer is referred to herein as activations. Eventually, a result is delivered from the output layers. Deep learning complex neural networks are designed to emulate how the human brain works, so computers can be trained to support poorly defined problems. Therefore, deep learning is used to predict an output given a set of inputs, and either supervised learning or unsupervised learning can be used to facilitate such results.

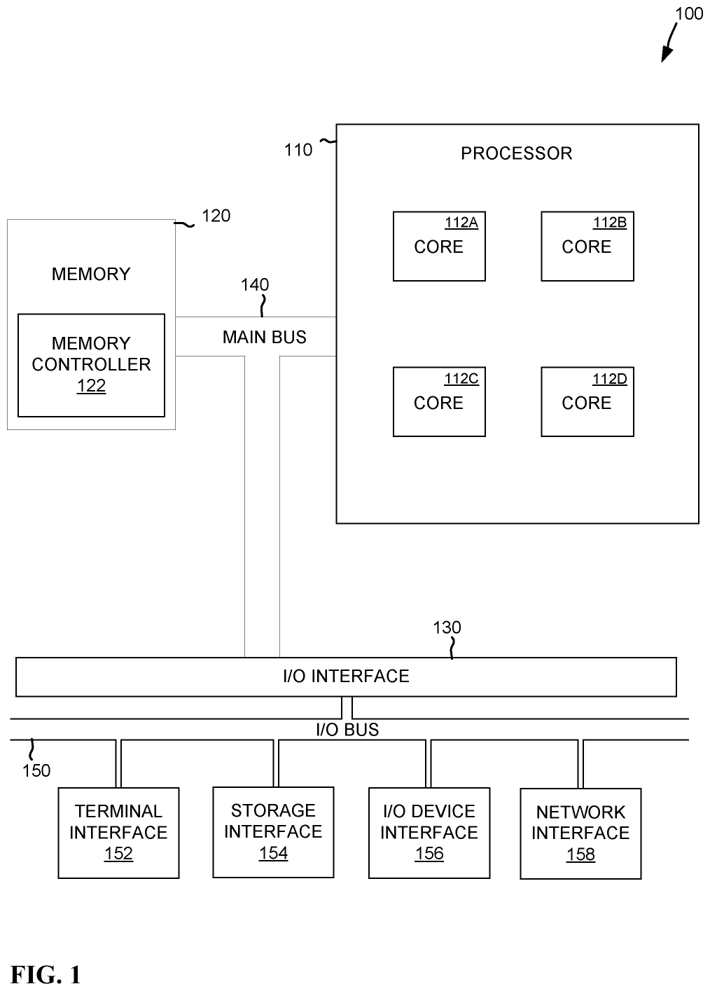

FIG. 1 depicts the representative major components of an example computer system 100 (alternatively, computer) that may be used, in accordance with some embodiments of the present disclosure. It is appreciated that individual components may vary in complexity, number, type, and/or configuration. The particular examples disclosed are for example purposes only and are not necessarily the only such variations. The computer system 100 may include a processor 110, memory 120, an input/output interface (herein I/O or I/O interface) 130, and a main bus 140. The main bus 140 may provide communication pathways for the other components of the computer system 100. In some embodiments, the main bus 140 may connect to other components such as a specialized digital signal processor (not depicted).

The processor 110 of the computer system 100 may be comprised of one or more cores 112A, 112B, 112C, 112D (collectively 112). The processor 110 may additionally include one or more memory buffers or caches (not depicted) that provide temporary storage of instructions and data for the cores 112. The cores 112 may perform instructions on input provided from the caches or from the memory 120 and output the result to caches or the memory. The cores 112 may be comprised of one or more circuits configured to perform one or more methods consistent with embodiments of the present disclosure. In some embodiments, the computer system 100 may contain multiple processors 110. In some embodiments, the computer system 100 may be a single processor 110 with a singular core 112.

The memory 120 of the computer system 100 may include a memory controller 122. In some embodiments, the memory 120 may include a random-access semiconductor memory, storage device, or storage medium (either volatile or non-volatile) for storing data and programs. In some embodiments, the memory may be in the form of modules (e.g., dual in-line memory modules). The memory controller 122 may communicate with the processor 110, facilitating storage and retrieval of information in the memory 120. The memory controller 122 may communicate with the I/O interface 130, facilitating storage and retrieval of input or output in the memory 120.

The I/O interface 130 may include an I/O bus 150, a terminal interface 152, a storage interface 154, an I/O device interface 156, and a network interface 158. The I/O interface 130 may connect the main bus 140 to the I/O bus 150. The I/O interface 130 may direct instructions and data from the processor 110 and memory 120 to the various interfaces of the I/O bus 150. The I/O interface 130 may also direct instructions and data from the various interfaces of the I/O bus 150 to the processor 110 and memory 120. The various interfaces may include the terminal interface 152, the storage interface 154, the I/O device interface 156, and the network interface 158. In some embodiments, the various interfaces may include a subset of the aforementioned interfaces (e.g., an embedded computer system in an industrial application may not include the terminal interface 152 and the storage interface 154).

Logic modules throughout the computer system 100 including but not limited to the memory 120, the processor 110, and the I/O interface 130 may communicate failures and changes to one or more components to a hypervisor or operating system (not depicted). The hypervisor or the operating system may allocate the various resources available in the computer system 100 and track the location of data in memory 120 and of processes assigned to various cores 112. In embodiments that combine or rearrange elements, aspects and capabilities of the logic modules may be combined or redistributed. These variations would be apparent to one skilled in the art.

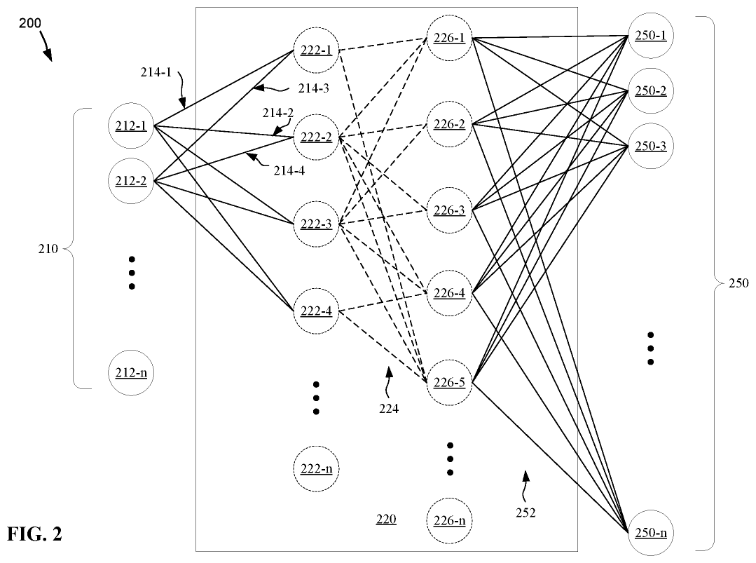

FIG. 2 depicts an example neural network (alternatively, “network”) 200 representative of one or more artificial neural networks, consistent with some embodiments of the present disclosure. The neural network 200 is made up of a plurality of layers. The network 200 includes an input layer 210, a hidden section 220, and an output layer 250. Though network 200 depicts a feed-forward neural network, it should be appreciated that other neural networks layouts may also be contemplated, such as a recurrent neural network layout (not depicted). In some embodiments, the network 200 may be a design-and-run neural network and the layout depicted may be created by a computer programmer. In some embodiments, the network 200 may be a design-by-run neural network, and the layout depicted may be generated by the input of data and by the process of analyzing that data according to one or more defined heuristics. The network 200 may operate in a forward propagation by receiving an input and outputting a result of the input. The network 200 may adjust the values of various components of the neural network by a backward propagation (back propagation).

The input layer 210 includes a series of input neurons 212-1, 212-2, up to 212-n (collectively, 212) and a series of input connections 214-1, 214-2, 214-3, 214-4, etc. (collectively, 214). The input layer 210 represents the input from data that the neural network is supposed to analyze data (e.g., images, sounds, text, hardware sensor information). Each input neuron 212 may represent a subset of the input data.

For example, input neuron 212-1 may be the first pixel of a picture, input neuron 212-2 may be the second pixel of the picture, etc. The number of input neurons 212 may correspond to the size of the input. For example, when neural network 200 is designed to analyze images that are 256 pixels by 256 pixels, the neural network layout may include a series of 65,536 input neurons. The number of input neurons 212 may correspond to the type of input. For example, when the input is a color image that is 256 pixels by 256 pixels, the neural network layout may include a series of 196,608 input neurons (65,536 input neurons for the red values of each pixel, 65,536 input neurons for the green values of each pixel, and 65,536 input neurons for the blue values of each pixel). The type of input neurons 212 may correspond to the type of input. In a first example, a neural network may be designed to analyze images that are black and white, and each of the input neurons may be a decimal value between 0.00001 and 1 representing the grayscale shades of the pixel (where 0.00001 represents a pixel that is completely white and where 1 represents a pixel that is completely black).

In a second example, a neural network may be designed to analyze images that are color, and each of the input neurons may be a three-dimensional vector to represent the color values of a given pixel of the input images (where the first component of the vector is a red whole-number value between 0 and 255, the second component of the vector is a green whole-number value between 0 and 255, and the third component of the vector is a blue whole-number value between 0 and 255).

The input connections 214 represent the output of the input neurons 212 to the hidden section 220. Each of the input connections 214 varies depending on the value of each input neuron 212 and based upon a plurality of weights (not depicted). For example, the first input connection 214-1 has a value that is provided to the hidden section 220 based on the input neuron 212-1 and a first weight. Continuing the example, the second input connection 214-2 has a value that is provided to the hidden section 220 based on the input neuron 212-1 and a second weight. Further continuing the example, the third input connection 214-3 based on the input neuron 212-2 and a third weight, etc. Alternatively stated, the input connections 214-1 and 214-2 share the same output component of input neuron 212-1 and the input connections 214-3 and 214-4 share the same output component of input neuron 212-2; all four input connections 214-1, 214-2, 214-3, and 214-4 may have output components of four different weights. Though the network neural 200 may have different weightings for each connection 214, some embodiments may contemplate weights that are similar. In some embodiments, each of the values of the input neurons 212 and the connections 214 may necessarily be stored in memory.

The hidden section 220 includes one or more layers that receive inputs and produce outputs. The hidden section 220 includes a first hidden layer of calculation neurons 222-1, 222-2, 222-3, 222-4, up to 222-n (collectively, 222); a second hidden layer of calculation neurons 226-1, 226-2, 226-3, 226-4, 226-5, up to 226-n (collectively 226); and a series of hidden connections 224 coupling the first hidden layer and the second hidden layer. It should be appreciated that neural network 200 only depicts one of many neural networks capable of performing ML operations consistent with some embodiments of the disclosure. Consequently, the hidden section 220 may be configured with more or less hidden layers (e.g., one hidden layer, seven hidden layers, twelve hidden layers, etc.) two hidden layers are depicted for example purposes.

The first hidden layer includes the calculation neurons 222-1, 222-2, 222-3, 222-4, up to 222-n. Each calculation neuron of the first hidden layer may receive as input one or more of the connections 214. For example, calculation neuron 222-1 receives input connection 214-1 and input connection 214-2. Each calculation neuron of the first hidden layer also provides an output. The output is represented by the dotted lines of hidden connections 224 flowing out of the first hidden. Each of the calculation neurons 222 performs an activation function during forward propagation. In some embodiments, the activation function may be a process of receiving several binary inputs, and calculating a single binary output (e.g., a perceptron). In some embodiments, the activation function may be a process of receiving several non-binary inputs (e.g., a number between 0 and 1, 0.671, etc.) and calculating a single non-binary output (e.g., a number between 0 and 1, a number between −0.5 and 0.5, etc.). Various functions may be performed to calculate the activation function (e.g., a sigmoid neurons or other logistic functions, tan h neurons, softplus functions, softmax functions, rectified linear units, etc.). In some embodiments, each of the calculation neurons 222 also contains a bias (not depicted). The bias may be used to decide the likelihood or valuation of a given activation function. In some embodiments, each of the values of the biases for each of the calculation neurons must necessarily be stored in memory.

The neural network 200 may include the use of a sigmoid neuron for the activation function of calculation neuron 222-1. An equation (Equation 1, stated below) may represent the activation function of calculation neuron 212-1 as f(neuron). The logic of calculation neuron 222-1 may be the summation of each of the input connections that feed into calculation neuron 222-1 (i.e., input connection 214-1 and input connection 214-3) which are represented in Equation 1 as j. For each j the weight w is multiplied by the value x of the given connected input neuron 212. The bias of the calculation neuron 222-1 is represented as b. Once each input connection j is summed the bias b is subtracted. Finalizing the operations of this example as follows: given a larger positive number of results from the summation and bias in activation f(neuron), the output of calculation neuron 222-1 approaches approximately 1; given a larger negative number of results from the summation and bias in activation f(neuron), the output of calculation neuron 222-1 approaches approximately 0; and given a number somewhere in between a larger positive number and a larger negative number of results from the summation and bias in activation f(neuron), the output varies slightly as the weights and biases vary slightly.

$$f ( neuron ) = \frac{1}{1 + exp ( - {\sum }_{j} {w}_{j} {x}_{j} - b )} \qquad Equation 1$$

The second hidden layer includes the calculation neurons 226-1, 226-2, 226-3, 226-4, 226-5, up to 226-n. In some embodiments, the calculation neurons 226 of the second hidden layer may operate similarly to the calculation neurons 222 first hidden layer. For example, the calculation neurons 226-1 to 226-n may each operate with a similar activation function as the calculation neurons 222-1 to 222-n. In some embodiments, the calculation neurons 226 of the second hidden layer may operate differently to the calculation neurons 222 of the first hidden layer. For example, the calculation neurons 226-1 to 226-n may have a first activation function, and the calculation neurons 222-1 to 222-n may have a second activation function.

Similarly, the connectivity to, from, and between the various layers of the hidden section 220 may also vary. For example, the input connections 214 may be fully connected to the first hidden layer and hidden connections 224 may be fully connected from the first hidden layer to the second hidden layer 226. In some embodiments, fully connected may mean that each neuron of a given layer may be connected to all the neurons of a previous layer. In some embodiments, fully connected may mean that each neuron of a given layer may function completely independently and may not share any connections. In a second example, the input connections 214 may not be fully connected to the first hidden layer and the hidden connections 224 may not be fully connected from the first hidden layer to the second hidden layer 226.

Further, the parameters to, from, and between the various layers of the hidden section 220 may also vary. In some embodiments, the parameters may include the weights and the biases. In some embodiments, there may be more or less parameters than the weights and biases. For purposes of example, neural network 200 may be in the form of a convolutional neural network or convolution network. The convolutional neural network may include a sequence of heterogeneous layers (e.g., an input layer 210, a convolution layer 222, a pooling layer 226, and an output layer 250). In such a network, the input layer may hold the raw pixel data of an image in a 3-dimensional volume of width, height, and color. The convolutional layer of such a network may output from connections that are only local to the input layer to identify a feature in a small section of the image (e.g., an eyebrow from a face of a first subject in a picture depicting four subjects, a front fender of a vehicle in a picture depicting a truck, etc.). Given this example, the convolutional layer may include weights and biases and additional parameters (e.g., depth, stride, and padding). The pooling layers of such a network may take as input the output of the convolutional layers but perform a fixed function operation (e.g., an operation that does not consider any weight or bias). Also given this example, the pooling layer may not contain any convolutional parameters and may also not contain any weights or biases (e.g., performing a down-sampling operation).

The output layer 250 includes a series of output neurons 250-1, 250-2, 250-3, up-to 250-n (collectively, 250). The output layer 250 holds a result of the analyzation of the neural network 200. In some embodiments, the output layer 250 may be a categorization layer used to identify a feature of the input to the network 200. For example, the network 200 may be a classification network trained to identify Arabic numerals. In such an example, the network 200 may include ten output neurons 250 corresponding to which Arabic numeral the network has identified (e.g., output neuron 250-2 having a higher activation value than output neurons 250 may indicate the neural network determined an image contained the number ‘1’). In some embodiments, the output layer 250 may be a real-value target (e.g., trying to predict a result when an input is a previous set of results) and there may be only a singular output neuron (not depicted). The output layer 250 is fed from an output connection 252. The output connection 252 provides the activations from the hidden section 220. In some embodiments, the output connections 252 may include weights and the output neurons 250 may include biases.

Training the neural network depicted by neural network 200 may include performing back propagation. Back propagation is different from forward propagation. Forward propagation may include feeding of data into the input neurons 210; performing the calculations of the connections 214, 224, 252; and performing the calculations of the calculation neurons 222 and 226. The forward propagation may also be the layout of a given neural network (e.g., recurrence, number of layers, number of neurons in one or more layers, layers being fully connected or not to other layers, etc.). Back propagation may be used to determine an error of the parameters (e.g., the weights and the biases) in the network 200 by starting with the output neurons 250 and propagating the error backward through the various connections 252, 224, 214 and layers 226, 222, respectively.

Back propagation includes performing one or more algorithms based on one or more training data to reduce the difference between what a given neural network determines from an input and what the given neural network should determine from the input. The difference between a network determination and the correct determination may be called the objective function (alternatively, the cost function). When a given neural network is initially created and data is provided and calculated through a forward propagation the result or determination may be an incorrect determination.

For example, neural network 200 may be a classification network; may be provided with a 128 pixel by 250-pixel image input that contains the number ‘3’; and may determine that the number is most likely ‘9’ and is second most likely ‘2’ and is third most likely ‘3’ (and so on with the other Arabic numerals). Continuing the example, performing a back propagation may alter the values of the weights of connections 214, 224, and 252; and may alter the values of the biases of the first layer of calculation neurons 222, the second layer of calculation neurons 226, and the output neurons 250. Further continuing the example, the performance of the back propagation may yield a future result that is a more accurate classification of the same 128 pixel by 250-pixel image input that contains the number ‘3’ (e.g., more closely ranking ‘9’, ‘2’, then ‘3’ in order of most likely to least likely, ranking ‘9’, then ‘3’, then ‘2’ in order of most likely to least likely, ranking ‘3’ the most likely number, etc.).

Equation 2 provides an example of the objective function (“example function”) in the form of a quadratic cost function (e.g., mean squared error)—other functions may be selected, and the mean squared error is selected for example purposes. In Equation 2, all of the weights may be represented by w and biases may be represented by b of neural network 200. The network 200 is provided a given number of training inputs n in a subset (or entirety) of training data that have input values x. The network 200 may yield output a from x and should yield a desired output y(x) from x. Back propagation or training of the network 200 should be a reduction or minimization of the objective function ‘O(w,b)’ via alteration of the set of weights and biases. Successful training of network 200 should not only include the reduction of the difference between the answer a and the correct answers y(x) for the input values x, but given new input values (e.g., from additional training data, from validation data, etc.).

$$O ( w , b ) ≡ \frac{1}{2 n} {\sum }_{χ} {‖ y ( x ) - a ‖}^{2} \qquad Equation 2$$

Many options may be utilized for back propagation algorithms in both the objective function (e.g., mean squared error, cross-entropy cost function, accuracy functions, confusion matrix, precision-recall curve, mean absolute error, etc.) and the reduction of the objective function (e.g., gradient descent, batch-based stochastic gradient descent, Hessian optimization, momentum-based gradient descent, etc.). Back propagation may include using a gradient descent algorithm (e.g., computing partial derivatives of an objective function in relation to the weights and biases for all of the training data). Back propagation may include determining a stochastic gradient descent (e.g., computing partial derivatives of a subset the training inputs in a subset or batch of training data). Additional parameters may be involved in the various back propagation algorithms (e.g., the learning rate for the gradient descent). Large alterations of the weights and biases through back propagation may lead to incorrect training (e.g., overfitting to the training data, reducing towards a local minimum, reducing excessively past a global minimum, etc.). Consequently, modification to objective functions with more parameters may be used to prevent incorrect training (e.g., utilizing objective functions that incorporate regularization to prevent overfitting). Also, consequently, the alteration of the neural network 200 may be small in any given iteration. Back propagation algorithms may need to be repeated for many iterations to perform accurate learning as a result of the necessitated smallness of any given iteration.

For example, neural network 200 may have untrained weights and biases, and back propagation may involve the stochastic gradient descent to train the network over a subset of training inputs (e.g., a batch of 10 training inputs from the entirety of the training inputs). Continuing the example, network 200 may continue to be trained with a second subset of training inputs (e.g., a second batch of 10 training input from the entirety other than the first batch), which can be repeated until all of the training inputs have been used to calculate the gradient descent (e.g., one epoch of training data). Stated alternatively, if there are 10,000 training images in total, and one iteration of training uses a batch size of 100 training inputs, 1,000 iterations would be needed to complete an epoch of the training data. Many epochs may be performed to continue training of a neural network. There may be many factors that determine the selection of the additional parameters (e.g., larger batch sizes may cause improper training, smaller batch sizes may take too many training iterations, larger batch sizes may not fit into memory, smaller batch sizes may not take advantage of discrete GPU hardware efficiently, too little training epochs may not yield a fully trained network, too many training epochs may yield overfitting in a trained network, etc.). Further, network 200 may be evaluated to quantify the performance of evaluating a dataset, such as by use of an evaluation metric (e.g., mean squared error, cross-entropy cost function, accuracy functions, confusion matrix, precision-recall curve, mean absolute error, etc.).

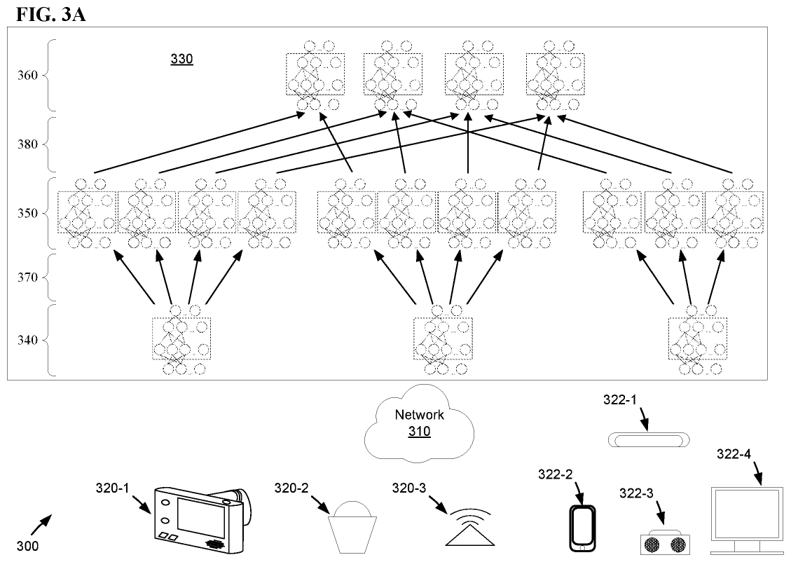

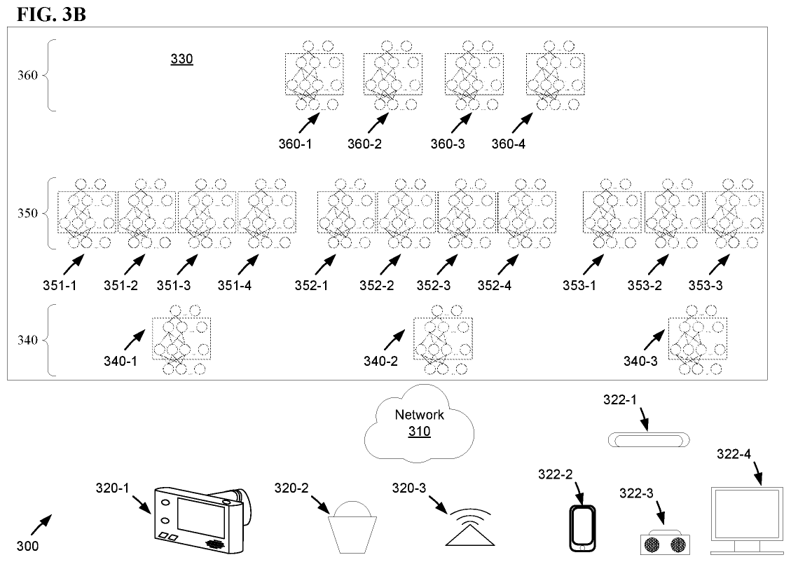

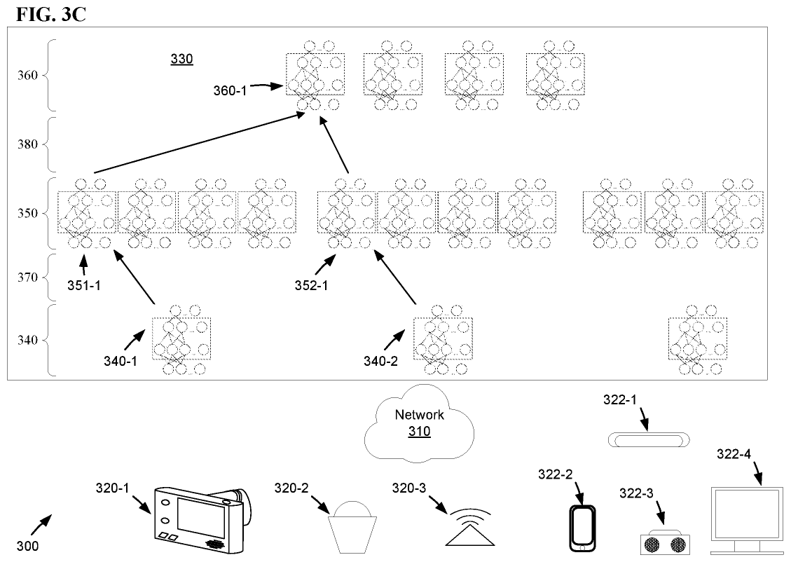

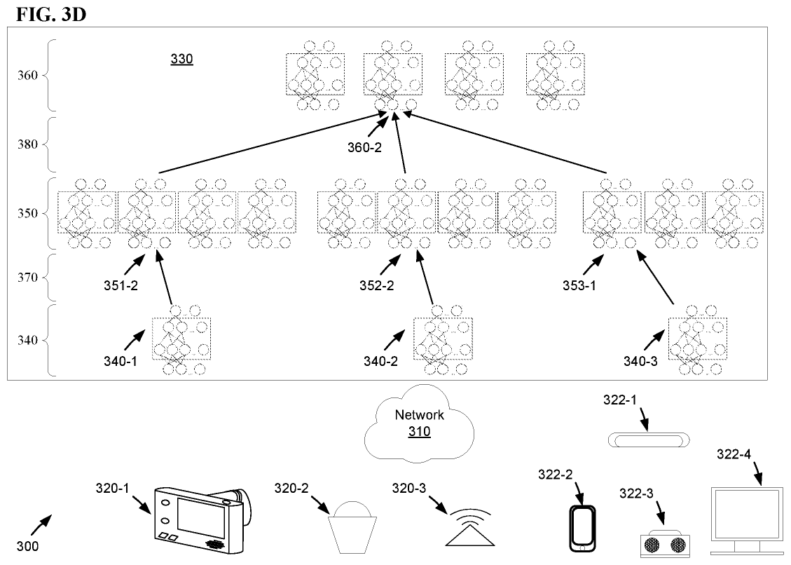

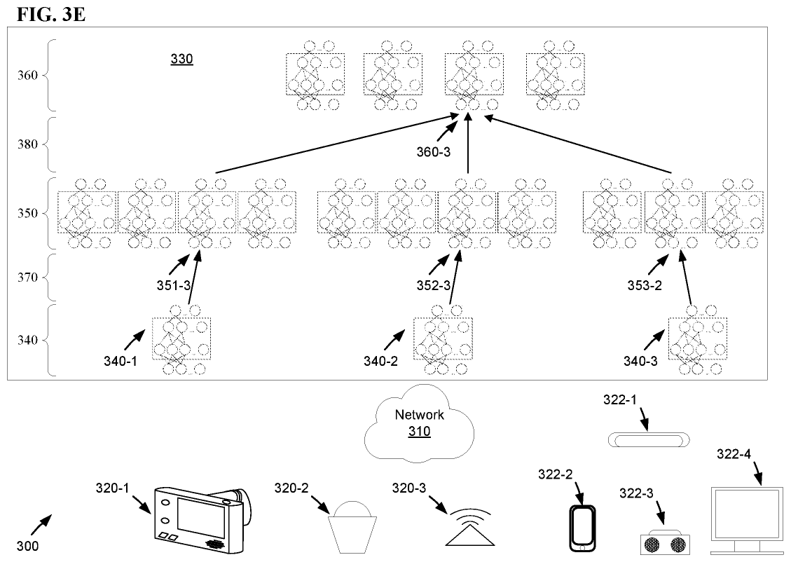

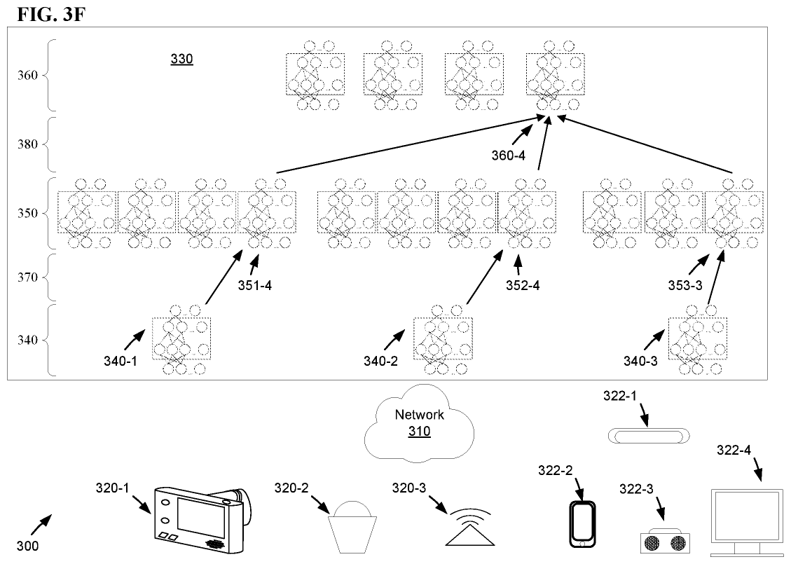

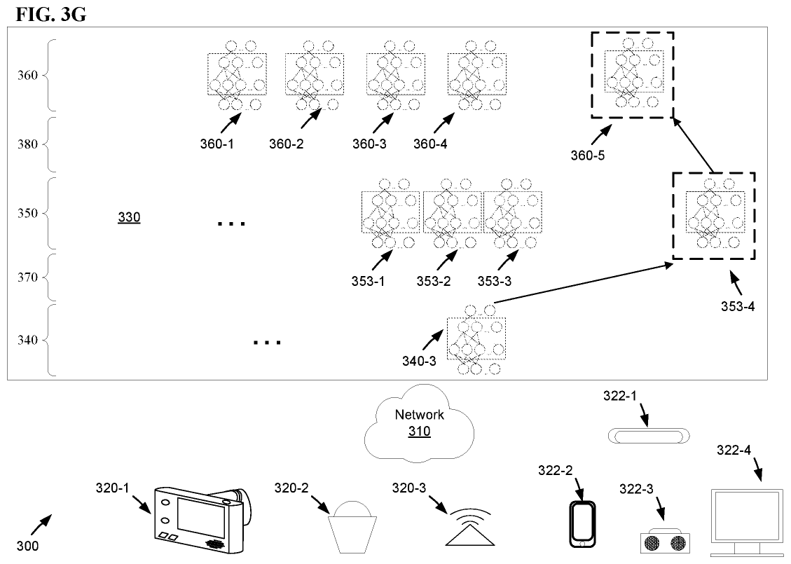

FIGS. 3A-3G depict a system 300 for performing artificial intelligence in an IoT ecosystem, consistent with some embodiments of the disclosure. FIGS. 3A and 3B depict example configurations of system 300. FIGS. 3C, 3D, 3E, 3F, and 3G depict an example of data flowing through system 300.

FIG. 3A depicts a system 300 for performing artificial intelligence in an IoT ecosystem, consistent with some embodiments of the disclosure. System 300 may include the following: a communications network 310 for communicatively coupling the various components; a plurality of first IoT devices 320-1, 320-2, and 320-3 (collectively, first IoT devices 320); a plurality of second IoT devices 322-1, 322-2, 322-3, and 322-4 (collectively, second IoT devices 322), and a Multi-Level Coordinated Internet of Things Artificial Intelligence (“MLC”) 330.

Network 310 can be implemented using any number of any suitable physical and/or logical communications topologies. The network 310 can include one or more private or public computing networks. For example, network 310 may comprise a private network (e.g., a network with a firewall that blocks non-authorized external access) that is associated with a particular function or workload (e.g., communication, streaming, hosting, sharing), or set of software or hardware clients. Alternatively, or additionally, network 310 may comprise a public network, such as the Internet. Consequently, network 310 may form part of a data unit network (e.g., packet-based) for instance, a local-area network, a wide-area network, and/or a global network.

Network 310 can include one or more servers, networks, or databases, and can use one or more communication protocols to transfer data between other components of system 300. Furthermore, although illustrated in FIG. 3A as a single entity, in other examples network 310 may comprise a plurality of networks, such as a combination of public and/or private networks. The communications network 310 can include a variety of types of physical communication channels or “links.” The links can be wired, wireless, optical, and/or any other suitable media. In addition, the communications network 310 can include a variety of network hardware and software (not depicted) for performing routing, switching, and other functions, such as routers, switches, base stations, bridges or any other equipment that may be useful to facilitate communicating data.

The first IoT devices 320 and the second IoT devices 322 may be real-world objects that include computing resources. For example, each of the first IoT devices 320 and the second IoT devices 322 may include a memory for storing instructions and data, a processor for processing the data based on the instructions, and an I/O for communicating with others of the IoT devices, such as computer 100 depicted in FIG. 1. The first IoT devices 320 and the second IoT devices 322 may be configured to communicate with each other and share data, such as through network 310.

The first IoT devices 320 may include input sensors and may be configured to capture information regarding an environment, such a real-world environment where the IoT devices are located. For example, first IoT device 320-1 may be a video transceiver configured to capture a visible light image or series of images of the real-world environment. Further, first IoT device 320-2 may be a motion detector configured to capture movement of objects in a space of the real-world environment. Further still, first IoT device 320-3 may be a wireless network transceiver that is configured to capture network traffic in the real-world environment.

The second IoT devices 322 may be configured to provide output to the real-world environment. For example, second IoT device 322-1 may be a smart light that is configured to illuminate a room or rooms (not depicted) in the real-world environment. Further, second IoT device 322-2 may be a smartphone that is configured to provide notifications and statuses of the other IoT devices. Further still, second IoT device 322-3 may be a smart speaker that is configured to output status information and to play audible noises (e.g., sounds, music) in one or more rooms of the real-world environment. Yet further still, second IoT device 322-4 may be a smart appliance (such as a smart television) configured to perform tasks (such as displaying a program).

MLC 330 may be a coordinated collection of ML operations that may perform one or more operations related to IoT. In detail, MLC 330 may include a first plurality of ML operations 340, a second plurality of ML operations 350, and a third plurality of ML operations 360. The various ML operations may be organized into levels. Specifically, the first plurality of ML operations 340 may be considered a first level, the second plurality of ML operations 350 may be considered a second level, and the third plurality of ML operations 360 may be considered a third level. As will be described in FIGS. 3C-3G the MLC may be configured to provide an AI path or hierarchy. For example, the MLC may direct the first plurality of ML operations 340 to the second plurality of ML operations 350, at 370. Further, the MLC may direct the second plurality of ML operations 350 to the third plurality of ML operations 360, at 380.

FIG. 3B depicts an additional view of the system 300 for performing artificial intelligence in an IoT ecosystem, consistent with some embodiments of the disclosure. Specifically, FIG. 3B depicts each of the ML operations of the MLC 330, including the first plurality of ML operations 340, the second plurality of ML operations 350, and the third plurality of ML operations 360. Each of the ML operations of the MLC 330 may be configured as an instance of a NN and/or ML model, such as an instance of neural network 200.

Each NN and/or ML model of the MLC 330 may execute machine learning on data using one or more of the following example techniques: autoencoders, K-nearest neighbor (KNN), learning vector quantization (LVQ), self-organizing map (SOM), logistic regression, ordinary least squares regression (OLSR), linear regression, stepwise regression, masking, multivariate adaptive regression spline (MARS), regression, ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, embedding, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, classification, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

The first plurality of ML operations 340 may include one or more ML models and/or NNs. In detail, the first plurality of ML operations 340 may include NNs 340-1, 340-2, and 340-3. NNs 340-1, 340-2, and 340-3 may be configured to operate on IoT device data. For example, NN 340-1 may include input neurons that are configured to receive data from first IoT device 320-1, such as pixels of a video feed. Further, NN 340-2 may include input neurons configured to receive data from first IoT device 320-3, such as motion detection signals. Further still, NN 340-3 may include input neurons that are configured to receive data from first IoT device 320-3, such as network packets, Internet Protocol Addresses, and the like.

In some embodiments, the first plurality of ML operations 340 may be trained independent of any particular IoT task that is to be performed by system 300. In detail, NNs 340-1, 340-2, and 340-3 may be trained on input data from various sensors and IoT devices without respect to or without knowledge of a specific IoT task. Resultantly, NNs 340-1, 340-2, and 340-3 may each include one or more layers of neurons that process input data from IoT devices without generating output that considers or is based on an IoT task. For example, NN 340-2 may process motion data from first IoT device 320-2 without consideration of a use case or task to be performed.

In some embodiments, the first plurality of ML operations 340, including NNs 340-1, 340-2, and 340-3, may perform embedding operations. For example, NN 340-1 may be configured as an auto-encoder NN that performs a training by filtering input data into a vector in a hidden layer that is smaller than the number of input neurons. Further, NN 340-1 may also be configured to take the small number of neurons in the hidden layer and be trained to output as an auto-decoder a signal that is similar to the output neurons. Upon successfully training, NN 340-1 may be altered, by removing the decoder portion, to leave only an embedding.

The second plurality of ML operations 350 may include one or more ML models and/or NNs. In detail, the second plurality of ML operations 350 may include first device/task NNs 351-1, 351-2, 351-3, 351-4 (collectively, 351); second device/task NNs 352-1, 352-2, 352-3, 352-4 (collectively 352); and third device/task NNs 353-1, 352-2, and 352-3. The various NNs of the second plurality of ML operations 350 may operate based on input data of IoT devices and IoT tasks.

For example, first device/task NNs 351 may operate on a combination of IoT device data from the first IoT device 320-1 and IoT task data such as a particular type of task or operation. More specifically, NN 351-1 may be a NN configured to perform ML operations related to a motion sensing task including motion task input data and video data from NN 340-1. NN 351-2 may be a NN configured to perform ML operations related to an activity sensing task including activity task input data and video data from NN 340-1. NN 351-3 may be a NN configured to perform ML operations related to an occupancy sensing task including occupancy task input data and video data from NN 340-1. NN 351-4 may be a NN configured to perform ML operations related to a threat sensing task including threat task input data and video data from NN 340-1.

Similarly, second device/task NNs 352 may operate on a combination of IoT device data from the first IoT device 320-2 and IoT task data. Specifically, NN 352-1 may have input data of the motion sensing task and motion data from NN 340-2. NN 352-2 may have input data of the activity sensing task and the motion data from NN 340-2. NN 352-3 may have input data of the occupancy sensing task and the motion data from NN 340-2. NN 352-4 may have input data of the threat sensing task and the motion data from NN 340-2.

Similarly, third device/task NNs 353 may operate on a combination of IoT device data from the first IoT device 320-3 and IoT task data. Specifically, NN 353-1 may have input data of the motion sensing task and network data from NN 340-3. NN 353-2 may have input data of the activity sensing task and the network data from NN 340-3. NN 353-3 may have input data of the occupancy sensing task and the network data from NN 340-2.

In some embodiments, the second plurality of ML operations 350, including first device/task NNs 351-1, 351-2, 351-3, 351-4, may each be configured to perform particular ML operations. For example, NN 351-1 may be configured as an auto-encoder NN that performs a training by filtering input data. Further, NN 351-1 may also be configured to be trained to output as an auto-decoder. Upon successfully training, NN 351-1 may be altered, by removing the decoder portion, to leave only an embedding. Further, after being configured as an embedding, NN 351-1 may be configured by adding specific layers of NN operations. For example, mask layers and/or transformer layers may be added to NN 351-1. The mask layers and/or transformer layers may be based on a particular IoT task, such as motion detection in a video signal. Each of the second device/task NNs 352-1, 352-2, 352-3, 352-4 and third device/task NNs 353-1, 352-2, 352-3 may be similarly configured to perform specific ML operations regarding a combination of a particular IoT device and a specific IoT task. Each NN of the second plurality of ML operations 350 may have a similar loss function, such as a task learning loss score for updating of the weights of various layers of neurons.

The third plurality of ML operations 360 may include one or more ML models and/or NNs. In detail, the third plurality of ML operations 360 may include first IoT task NN 360-1, second IoT task NN 360-2, third IoT task NN 360-3, and fourth IoT task NN 360-4. The various NNs of the third plurality of ML operations 360 may operate based on input data of IoT devices and IoT tasks. For example, first IoT task NN 360-1 may be a NN configured to perform a motion tracking task. The second IoT task NN 360-2 may be a NN configured to perform an activity recognition task. The third IoT task NN 360-3 may be a NN configured to perform an occupancy detection task. The fourth IoT task NN 360-4 may be a NN configured to perform a threat analysis task.

In some embodiments, the third plurality of ML operations 360 may each be configured to perform particular ML operations. For example, NN 360-1 may be configured as a feed forward NN. In another example, NN 360-1 may be configured as a prediction NN. In another example, NN 360-1 may be configured as a regression NN. NN 360-1 may be fine-tuned for the particular IoT task to be performed.

In some embodiments, the NNs 360-1, 360-2, 360-3, and 360-4 may share one or more components with the second plurality of ML operations 350. For example, the second plurality of ML operations and the third plurality of ML operations 360 may share a loss function. The shared loss function may be a multi-dimensional function. Upon training or updating of a NN of the second level, other NNs on the second level and other NNs on the third level may be improved or updated. Similarly, upon training or updating of a NN on the third level, other NNs on the second level and third level may be improved or updated. Consequently, operations related to one IoT device and/or IoT task may improve the performance and accuracy of other NNs as related to other devices and/or tasks.

FIGS. 3C, 3D, 3E, 3F, and 3G depict an example of data movement through system 300. Data may flow through MLC 330 in response to one or more requests. Specifically, MLC 330 may be a part of an IoT ecosystem and may be configured to perform AI in response to a request, such as an IoT request. Specifically, one or more of the first IoT devices 320, second IoT devices 330, MLC 330, or another relevant computer (not depicted) of system 300 may be configured to monitor for IoT requests, the IoT request may be related to one or more IoT tasks (e.g., adjusting settings of the second IoT devices 322). In response to detecting an IoT request, MLC 330 may operate by performing a plurality of ML operations. In response to the ML operations, an IoT output may be identified by the MLC 330. In response to the IoT output the MLC 330 may generate an IoT response for responding to the IoT request. The various tasks may be related to more complex IoT operations. For example, an IoT task may be based on a particular condition, such as a person being present in a room. The MLC 330 may operate by performing the AI regarding input data from the IoT devices (e.g., first IoT devices 320 and/or second IoT devices 322) to make a determination, such as the presence of a person that is antecedent of the IoT task being triggered.

FIG. 3C depicts a first artificial intelligence (“AI”) path of data related to a first IoT task of the system 300, consistent with some embodiments of the disclosure. MLC 330 may receive an IoT request to perform an IoT task. The request may be to perform a motion tracking task. In response to the request, the MLC 330 may instruct a plurality of first ML operations to be performed. For example, in response to the request to perform a motion tracking task, the MLC 330 may instruct first ML operations be performed by NN 340-1 based on inputs from first IoT device 320-1 and additional first ML operations be performed by NN 340-2 on inputs from first IoT device 320-2. The first ML operations may yield a first ML output (e.g., a vector, a set of values) from NNs 340-1 and 340-2.

In response to receiving the outputs, MLC 330 may instruct a plurality of second ML operations to be executed, at 370. For example, in response to receiving the first ML outputs from NN 340-1, MLC 330 may instruct second ML operations to be executed by NN 351-1. The instruction of execution to NN 351-1 may be to use the output of NN 340-1 as input. Further, in response to receiving the first ML outputs from NN 340-2, MLC 330 may instruct second ML operations to be executed by NN 352-1. The instruction of execution to NN 352-1 may be to use the output of NN 340-2 as input. The second ML operations may yield a second ML output (e.g., a vector, a set of values) from NNs 351-1 and 352-1.

In response to obtaining the outputs, MLC 330 may instruct a plurality of third ML operations to be run, at 380. For example, in response to receiving the second ML outputs from NN 351-1, and the second ML outputs from NN 352-1, MLC 330 may instruct third ML operations to be executed by NN 360-1. The instruction of running to NN 360-1 may be to use the output of NN 351-1 and the output of NN 352-1 as input. The third ML operations may yield a third ML output (e.g., a vector, a set of values) from NN 360-1. The third ML output may be considered an IoT output.

In response to identifying the IoT output, MLC 330 may perform one or more AI IoT response actions. For example, MLC 330 may identify motion with an environment based on sensor data (from first IoT devices 320-1 and 320-2) and IoT task data. Motion related to a particular IoT task such as a person entering or exiting a room in the environment.

FIG. 3D depicts a second AI path of data related to a second IoT task of the system 300, consistent with some embodiments of the disclosure. MLC 330 may receive an IoT request to perform an IoT task. The request may be to perform an activity recognition task. In response to the request, the MLC 330 may instruct a plurality of first ML operations to be performed. For example, in response to the request to perform an activity recognition task, the MLC 330 may instruct first ML operations be performed by NN 340-1 based on inputs from first IoT device 320-1, first ML operations be performed by NN 340-2 on inputs from first IoT device 320-2, and first ML operations be performed by NN 340-1 on inputs from first IoT device 320-3. The first ML operations may yield a first ML output (e.g., a vector, a set of values) from NNs 340-1, 340-2, and NN 340-3.

In response to receiving the first ML output, MLC 330 may instruct a plurality of second ML operations to be executed, at 370. For example, in response to receiving the first ML outputs from NN 340-1, MLC 330 may instruct second ML operations to be executed by NN 351-2. The instruction of execution to NN 351-2 may be to use the output of NN 340-1 as input. Further, in response to receiving the first ML outputs from NN 340-2, MLC 330 may instruct second ML operations to be executed by NN 352-2. The instruction of execution to NN 352-2 may be to use the output of NN 340-2 as input. Further still, in response to receiving the first ML outputs from NN 340-3, MLC 330 may instruct second ML operations to be executed by NN 353-1. The instruction of execution to NN 353-1 may be to use the output of NN 340-1 as input. The second ML operations may yield a second ML output (e.g., a vector, a set of values) from NNs 351-2, 352-2, and 353-1.

In response to obtaining the second ML output, MLC 330 may instruct a plurality of third ML operations to be run, at 380. For example, in response to receiving the second ML outputs from NN 351-2, the second ML outputs from NN 352-2, and the second ML outputs from NN 353-1, MLC 330 may instruct third ML operations to be executed by NN 360-2. The instruction of running to NN 360-2 may be to use the output of NN 351-2, the output of NN 352-2, and the output of NN 353-1 as input. The third ML operations may yield a third ML output (e.g., a vector, a set of values) from NN 360-2. The third ML output may be considered an IoT output.

In response to identifying the IoT output, MLC 330 may perform one or more AI IoT response actions. For example, MLC 330 may identify an activity is being performed within an environment based on sensor data (from first IoT devices 320-1, 320-2, and 320-3) and IoT task data. Activity related to a particular IoT task such as a person cooking a meal and operating one or more of the second IoT devices 322 in the environment.

FIG. 3E depicts a third AI path of data related to a third IoT task of the system 300, consistent with some embodiments of the disclosure. MLC 330 may receive an IoT request to perform an IoT task. The request may be to perform an occupancy detection task. In response to the request, the MLC 330 may instruct a plurality of first ML operations to be performed. For example, in response to the request to perform an activity recognition task, the MLC 330 may instruct first ML operations be performed by NN 340-1 based on inputs from first IoT device 320-1, first ML operations be performed by NN 340-2 on inputs from first IoT device 320-2, and first ML operations be performed by NN 340-1 on inputs from first IoT device 320-3. The first ML operations may yield a first ML output (e.g., a vector, a set of values) from NNs 340-1, 340-2, and NN 340-3.

In response to receiving the first ML output, MLC 330 may instruct a plurality of second ML operations to be executed, at 370. For example, in response to receiving the first ML outputs from NN 340-1, MLC 330 may instruct second ML operations to be executed by NN 351-3. The instruction of execution to NN 351-3 may be to use the output of NN 340-1 as input. Further, in response to receiving the first ML outputs from NN 340-2, MLC 330 may instruct second ML operations to be executed by NN 352-3. The instruction of execution to NN 352-3 may be to use the output of NN 340-2 as input. Further still, in response to receiving the first ML outputs from NN 340-3, MLC 330 may instruct second ML operations to be executed by NN 353-2. The instruction of execution to NN 353-2 may be to use the output of NN 340-3 as input. The second ML operations may yield a second ML output (e.g., a vector, a set of values) from NNs 351-3, 352-3, and 353-2.

In response to obtaining the second ML output, MLC 330 may instruct a plurality of third ML operations to be run, at 380. For example, in response to receiving the second ML outputs from NN 351-3, the second ML outputs from NN 352-3, and the second ML outputs from NN 353-2, MLC 330 may instruct third ML operations to be executed by NN 360-3. The instruction of running to NN 360-3 may be to use the output of NN 351-3, the output of NN 352-3, and the output of NN 353-2 as input. The third ML operations may yield a third ML output (e.g., a vector, a set of values) from NN 360-3. The third ML output may be considered an IoT output.

In response to identifying the IoT output, MLC 330 may perform one or more AI IoT response actions. For example, MLC 330 may identify an occupancy level is within an environment based on sensor data (from first IoT devices 320-1, 320-2, and 320-3) and IoT task data. Activity may be related to a particular IoT task, such as determining a predetermined threshold of people within a room in the environment.

FIG. 3F depicts a fourth AI path of data related to a fourth IoT task of the system 300, consistent with some embodiments of the disclosure. MLC 330 may receive an IoT request to perform an IoT task. The request may be to perform a threat analysis task. In response to the request, the MLC 330 may instruct a plurality of first ML operations to be performed. For example, in response to the request to perform an activity recognition task, the MLC 330 may instruct first ML operations be performed by NN 340-1 based on inputs from first IoT device 320-1, first ML operations be performed by NN 340-2 on inputs from first IoT device 320-2, and first ML operations be performed by NN 340-1 on inputs from first IoT device 320-3. The first ML operations may yield a first ML output (e.g., a vector, a set of values) from NNs 340-1, 340-2, and NN 340-3.

In response to receiving the first ML output, MLC 330 may instruct a plurality of second ML operations to be executed, at 370. For example, in response to receiving the first ML outputs from NN 340-1, MLC 330 may instruct second ML operations to be executed by NN 351-4. The instruction of execution to NN 351-4 may be to use the output of NN 340-1 as input. Further, in response to receiving the first ML outputs from NN 340-2, MLC 330 may instruct second ML operations to be executed by NN 352-4. The instruction of execution to NN 352-4 may be to use the output of NN 340-2 as input. Further still, in response to receiving the first ML outputs from NN 340-3, MLC 330 may instruct second ML operations to be executed by NN 353-3. The instruction of execution to NN 353-3 may be to use the output of NN 340-3 as input. The second ML operations may yield a second ML output (e.g., a vector, a set of values) from NNs 351-4, 352-4, and 353-3.

In response to obtaining the second ML output, MLC 330 may instruct a plurality of third ML operations to be run, at 380. For example, in response to receiving the second ML outputs from NN 351-4, the second ML outputs from NN 352-4, and the second ML outputs from NN 353-3, MLC 330 may instruct third ML operations to be executed by NN 360-4. The instruction of running to NN 360-4 may be to use the output of NN 351-4, the output of NN 352-4, and the output of NN 353-3 as input. The third ML operations may yield a third ML output (e.g., a vector, a set of values) from NN 360-4. The third ML output may be considered an IoT output.

In response to identifying the IoT output, MLC 330 may perform one or more AI IoT response actions. For example, MLC 330 may identify an existing threat from a malicious third party is within an environment based on sensor data (from first IoT devices 320-1, 320-2, and 320-3) and IoT task data. The threat may relate to a particular IoT task such as a predetermined threshold of network and/or physical activity related to the environment.

FIG. 3G depicts a new IoT task performed by the system 300, consistent with some embodiments of the disclosure. MLC 330 may receive an IoT request to perform an IoT task. The request may be an IoT network status task. In response to the new task, the MLC 330 may update the makeup of the various AI pathways and hierarchies. Specifically, one or more additional ML models and/or NNs may be created to perform a new AI pathway related to performing IoT network status tasks. For example, responsive to the new task, a new second level NN 353-4 and a new third level NN 360-5 may be created. In creation of the new AI pathway one or more existing components of MLC 330 may be reused. For example, second level NN 353-4 may receive input from existing NN 340-3. The reuse of components of the MLC 330 may reduce training time and processing power.

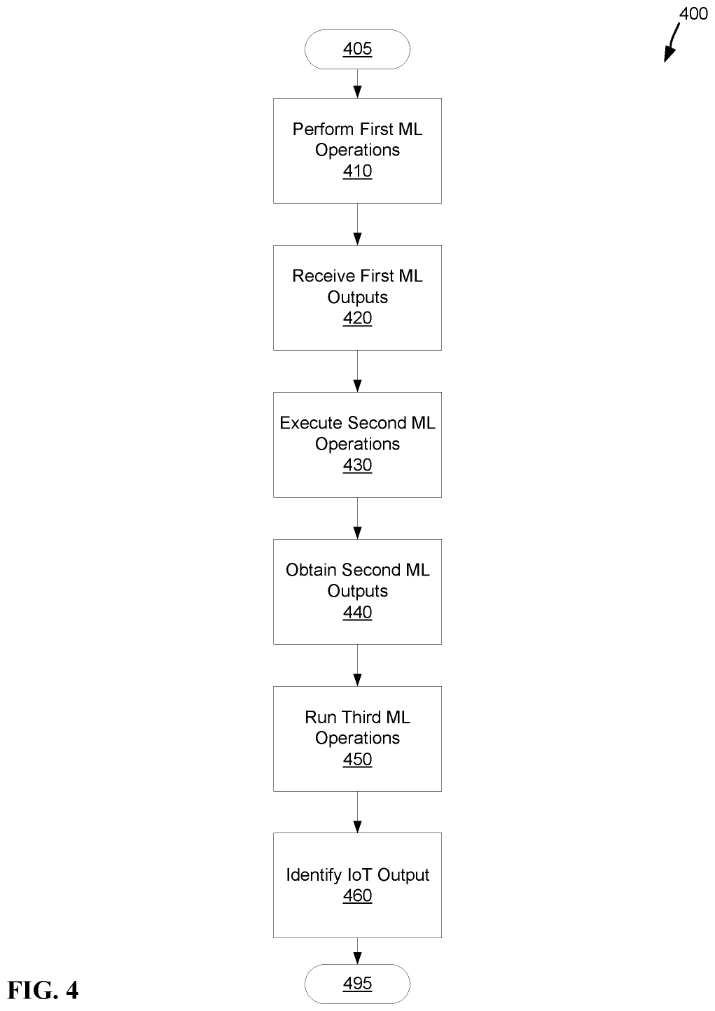

FIG. 4 depicts an example method 400 of performing artificial intelligence operations for an IoT ecosystem, consistent with some embodiments of the disclosure. The method 400 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.). Method 400 may be performed by a computer system, such as computer 100. Method 400 may be performed by a multi-modal artificial intelligence, such as MLC 330.

From start 405, a first plurality of ML operations may be performed at 410. The first plurality of ML operations may be performed on IoT input data. For example, an ecosystem of IoT devices may create data, such as sensor data. The first plurality of ML operations may be performed by a first level of NNs. Each first level NN may correspond to a single IoT device. For example, a motion sensor may provide motion sensor data as output, and the motion sensor data may be an input to one of the first level NNs. Continuing the example, a network sensor IoT device may provide network sensor data as output, and the network sensor data may be input to another of the first level NNs. Each of the first level NNs may not be related to a particular task. For example, one first level NN may operate on a video signal to perform ML operations (e.g., filtering, regression, embedding) on video signal data without considering or without awareness of a particular task that may be related to the video signal data.

At 420 a first machine learning output may be received. The first machine learning output may be received from the first level of NNs. At 430 a second plurality of ML operations may be executed. The second plurality of ML operations may be based on the first machine learning output that is received, at 420. The second plurality of ML operations may be performed by a second level of NNs. Each second level NN may correspond to a single IoT device and to a single IoT task. For example, network sensor IoT device data from a first level NN and IoT bandwidth measurements may be input into a single second level NN related to IoT bandwidth.

At 440 a second machine learning output may be obtained. The second machine learning output may be obtained from the second level NNs. At 450 a third plurality of ML operations may run. The third plurality of ML operations may be based on the second machine learning output that is obtained, at 440. The third plurality of ML operations may be based on multiple NNs from the second ML level.

At 460 IoT output may be identified. The IoT output may be identified from the third plurality of ML operations, at 450. After the IoT output is identified, at 460, method 400 may end at 495.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
performing, using a first machine learning level, a first plurality of machine learning operations on Internet of Things (IoT) input data in an IoT ecosystem;
receiving, from the first machine learning level, one or more first machine learning outputs;
executing, using a second machine learning level, a second plurality of machine learning operations on the one or more first machine learning outputs;
obtaining, from the second machine learning level, one or more second machine learning outputs;
running, using a third machine learning level, a third plurality of machine learning operations on the one or more second machine learning outputs; and
identifying, from the third machine learning level, an IoT output.

2. The method of claim 1, wherein the first machine learning level includes one or more first level neural networks.

3. The method of claim 2, wherein the IoT input data is captured from a plurality of IoT devices, and wherein each individual IoT device of the plurality of IoT devices corresponds with a single first level neural network of the one or more first level neural networks.

4. The method of claim 3, wherein the first machine learning operation is an embedding operation of the IoT input data.

5. The method of claim 3, wherein the first level neural networks are independent of any IoT task to be performed by the plurality of IoT devices.

6. The method claim 1, wherein the second machine learning level includes one or more second level neural networks.

7. The method of claim 6, wherein each second level neural network corresponds with a single IoT task.

8. The method of claim 6, wherein the second level neural networks are based on the IoT input data and based on IoT task data.

9. The method of claim 8, wherein the second machine learning operation is an embedding operation of the IoT input data and the IoT task data.

10. The method claim 1, wherein the third machine learning level includes one or more third level neural networks.

11. The method of claim 10, wherein each individual third level neural network receives input from multiple second level neural networks of the second machine learning level.

12. The method of claim 1, the method further comprises:
monitoring, before the performing, for an IoT request to perform an IoT task;
detecting, based on the monitoring and before the performing, the IoT request;
generating, based on the IoT output, an IoT response; and
responding, based on the IoT response, to the IoT request.

13. The method of claim 12, wherein
the IoT ecosystem contains a plurality IoT devices, and
the IoT input data is related to the subset of the plurality IoT devices.

14. The method of claim 13, wherein
the first machine learning level includes a plurality of first level neural networks, and
the first plurality of machine learning operations is performed by a subset of the first level neural networks that correspond to the subset of the plurality of IoT devices.

15. The method of claim 12, wherein
the IoT task includes IoT task data, and
the second machine learning level includes one or more second level neural networks configured to operate on the IoT input data and the IoT task data.

16. The method of claim 15, wherein
the third machine learning level includes one or more third level neural networks configured to operate on the IoT input data and the IoT task data.

17. The method of claim 1, wherein the method further comprises:
updating, using a training algorithm, at least one second level neural network of the second machine learning level; and
updating, using a second training algorithm, at least one third level neural network of the third machine learning level.

18. The method of claim 17, wherein the training algorithm and the second training algorithm share a loss function.

19. A system, the system comprising:
a memory, the memory containing one or more instructions; and
a processor, the processor communicatively coupled to the memory, the processor, in response to reading the one or more instructions, configured to:
perform, using a first machine learning level, a first plurality of machine learning operations on Internet of Things (IoT) input data in an IoT ecosystem;
receive, from the first machine learning level, one or more first machine learning outputs;
execute, using a second machine learning level, a second plurality of machine learning operations on the one or more first machine learning outputs;
obtain, from the second machine learning level, one or more second machine learning outputs;
run, using a third machine learning level, a third plurality of machine learning operations on the one or more second machine learning outputs; and
identify, from the third machine learning level, an IoT output.

20. A computer program product, the computer program product comprising:
one or more computer readable storage media; and
program instructions collectively stored on the one or more computer readable storage media, the program instructions configured to:
perform, using a first machine learning level, a first plurality of machine learning operations on Internet of Things (IoT) input data in an IoT ecosystem;
receive, from the first machine learning level, one or more first machine learning outputs;
execute, using a second machine learning level, a second plurality of machine learning operations on the one or more first machine learning outputs;
obtain, from the second machine learning level, one or more second machine learning outputs;
run, using a third machine learning level, a third plurality of machine learning operations on the one or more second machine learning outputs; and
identify, from the third machine learning level, an IoT output.
